(19) United States
(12) Patent Application Publication
(10) Pub. No.: US 2026/0252319 A1
(43) Pub. Date: Aug. 27, 2026

(54) CREATING AN APP, SUCH AS CREATING AN APP USING BRANCHING PROMPTS, METHOD, AND SYSTEM

(71) Applicants: Siemens Industry Software GmbH, Köln (DE); Mendix Technology B.V., Rotterdam (NL)

(72) Inventors: Filippos Petridis, Berlin (DE); Insuk Ko, Amstelveen (NL)

(21) Appl. No.: 19/064,006

(22) Filed: Feb. 26, 2025

(51) Int. Cl. G06F 8/35; G06F 8/10; G06F 8/61

(52) U.S. Cl. CPC G06F 8/35; G06F 8/10; G06F 8/61

(57) ABSTRACT

For an improved creation of an app, a computer-implemented method may include: providing an app development user interface (UI) of an app development platform to a user for developing the app; receiving first user input from the user, wherein the first user input is indicative of at least one app characteristic; determining a primary prompt based on the first user input, wherein the primary prompt indicates the respective app characteristic, and wherein the respective prompt is associated with a large language model to create the app; displaying the determined primary prompt to the user via the app development UI; receiving second user input from the user, wherein the second user input is indicative of a refined primary prompt; determining a subsidiary prompt based on the primary prompt and the second user input; and creating the app using the subsidiary prompt and the large language model.

### TECHNICAL FIELD

The present disclosure is directed, in general, to software management systems, in particular systems for creating and developing apps, which may be used to manage, build, test, deploy and iterate such apps (collectively referred to here-in as product systems).

### BACKGROUND

Recently, an increasing number of computer software products is used both for personal needs and for business needs in the form of applications, throughout the present patent document simply called “apps.” Such apps may be used in a mobile context as well as on cloud computing platforms and “on premise” and may provide a specific set of functions.

Currently, there exist product systems and solutions which support managing or developing such apps. Such product systems may benefit from improvements.

### SUMMARY

Variously disclosed embodiments include methods and computer systems that may be used to facilitate creating an app, such as creating an app using branching prompts. The scope of the present disclosure is defined solely by the appended claims and is not affected to any degree by the statements within this summary. The present embodiments may obviate one or more of the drawbacks or limitations in the related art.

According to a first aspect, a computer-implemented method for creating an app including an app user interface (UI) may include: providing an app development user interface (UI) of an app development platform to a user for developing the app; receiving first user input from the user, wherein the first user input is indicative of at least one app characteristic; determining a primary prompt based on the first user input, wherein the primary prompt indicates the respective app characteristic, and wherein the respective prompt is associated with a large language model to create the app; displaying the determined primary prompt to the user via the app development UI; receiving second user input from the user, wherein the second user input is indicative of a refined primary prompt; determining a subsidiary prompt based on the primary prompt and the second user input; and creating the app using the subsidiary prompt and the large language model.

According to a second aspect, a computer system may be arranged and configured to execute the acts of this computer-implemented method according to the first aspect.

According to a third aspect, a computer program product may include computer program code that, when executed by the computer system according to the second aspect, causes the computer system to carry out the method according to the first aspect.

According to a fourth aspect, a computer-readable medium may include the computer program product according to the third aspect. By way of example, the described computer-readable medium may be non-transitory and may further be a software component on a storage device.

The foregoing has outlined the technical features of the present disclosure so that those skilled in the art may better understand the detailed description that follows. Additional features and advantages of the disclosure are described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the detailed description below, various definitions for certain words and phrases are provided throughout this patent document and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

Embodiments are described below in greater detail.

### BRIEF DESCRIPTION OF THE DRAWINGS

FIGS. 1-6 depict a functional block diagram of example systems that facilitate creating an app, such as creating an app using branching prompts, in a product system, respectively.

FIG. 7 depicts an example schematic overview of app characteristics and app characteristic components available for branching prompts in the context of facilitating creating an app, such as creating an app using branching prompts, in a product system.

FIGS. 8-11 depict various aspects of an example app development user interfaces that facilitate creating an app, such as creating an app using branching prompts, in a product system, respectively.

FIGS. 12-14 depict a flow diagram of an example methodology that facilitates creating an app, such as creating an app using branching prompts, in a product system, respectively.

FIG. 15 depicts a block diagram of a data processing system in which an embodiment may be implemented.

### DETAILED DESCRIPTION

Various technologies that pertain to systems and methods for creating an app, such as creating an app using branching prompts, in a product system are described with reference to the drawings, where like reference numerals represent like elements throughout. The drawings discussed below, and the various embodiments used to describe the principles of the present disclosure in this patent document are by way of illustration only and may not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present patent document are described with reference to exemplary non-limiting embodiments.

An app may refer to a software program, which on execution, performs specific desired tasks. Several apps may be executed in a runtime environment containing one or more operating systems (“OSs”), virtual machines (e.g., supporting Java™ programming language), device drivers, etc.

Apps, including native apps, may be created, edited, and represented using traditional source code. Examples of such traditional source code include C, C++, Java, Flash, Python, Perl, and other script-based methods of representing an app. Developing, creating, and managing such script-based apps, or parts of such script-based apps may be accomplished by manual coding of suitably trained users.

Developers may use Application Development Frameworks (“ADFs”) (which are by themselves applications or apps) for implementing/developing desired apps. An ADF provides a set of pre-defined code/data modules that may be directly/indirectly used in the development of an app. An ADF may also provide tools such as an Integrated Development Environment (“IDE”), code generators, debuggers, etc., which facilitate a developer in coding/implementing the desired logic of the app in a faster/simpler manner.

An ADF may simplify app development by providing reusable components which may be used by app developers to define user interfaces (“UIs”) and app logic by, for example, selecting components to perform desired tasks and defining the appearance, behavior, and interactions of the selected components. Some ADFs are based on a model-view-controller design pattern that promotes loose coupling and easier app development and maintenance.

According to another approach, apps may also be created, edited, and represented using visual model-based representations. Unlike traditional source code implementations, such apps may be created, edited, and/or represented by drawing, moving, connecting, and/or disconnecting visual depictions of logical elements within a visual modeling environment. Visual model-based representations of apps may use symbols, shapes, lines, colors, shades, animations, and/or other visual elements to represent logic, data or memory structures or user interface elements. In order to program a traditional script-based app, programmers may be required to type out detailed scripts according to a complicated set of programming syntax rules. In contrast, programming a visual model-based app may, in some cases, be done by connecting various logical elements (e.g., action blocks and/or decision blocks) to create a visual flow chart that defines the app's operation. Similarly, defining data structures (e.g., variable types, database objects, or classes) and/or user interface elements (e.g., dropdown boxes, lists, text input boxes) in a visual model-based app may be done by drawing, placing, or connecting visual depictions of logical elements within a virtual workspace, as opposed to typing out detailed commands in a script. Visual-model based apps, including native apps, may therefore be more intuitive to program and/or edit compared to traditional script-based apps. In the present document, an approach is suggested to manage apps, such as to create an app including to develop a user interface of the app, which may involve the explained visual model-based representations.

For brevity, references to a “model,” a “visual model,” or an “application” or “app” may refer to visual model-based apps, including native apps, unless specifically indicated. In some cases, such visual model-based apps may represent complete, stand-alone apps for execution on a computer system. Visual model-based apps may also represent discrete modules that are configured to perform certain tasks or functions, but do not represent complete apps. Instead, such discrete modules may be inserted into a larger app or combined with other discrete modules to perform more complicated tasks. Examples of such discrete modules may include modules for validating a ZIP code, for receiving information regarding current weather from a weather feed, and/or for rendering graphics.

Visual models may be represented in two forms: an internal representation and one or more associated visual representations. The internal representation may be a file encoded according to a file format used by a modeling environment to capture and define the operation of an app (or part of an app). For example, the internal representation may define what inputs an app may receive, what outputs an app may provide, the algorithms and operations by which the app may arrive at results, what data the app may display, what data the app may store, etc. The internal representation may also be used to instruct an execution environment how to execute the logic of the app during run-time. Internal representations may be stored in the form of non-human-readable code (e.g., binary code). Internal representations may also be stored according to a binary stored JSON (java script object notation) format, and/or an XML format. At run-time, an execution engine may use an internal representation to compile and/or generate executable machine code that, when executed by a processor, causes the processor to implement the functionality of the model.

The internal representation may be associated with one or more visual representations. Visual representations may include visual elements that depict how an app's logic flows, but which are not designed to be compiled or executed. These visual representations may include, for example, flow-charts or decision trees that show a user how the app will operate. The visual models may also visually depict data that is to be received from the user, data that is to be stored, and data that is to be displayed to the user. These visual models may also be interactive, which allows a user to manipulate the model in an intuitive way. For example, visual representations may be configured to display a certain level of detail (e.g., number of branches, number of displayed parameters, granularity of displayed logic) by default. However, users may interact with the visual representation in order to show a desired level of detail. For example, users may display or hide branches of logic, and/or display or hide sets of parameters. Details relating to an element of the visual model may be hidden from view by default but may appear in a sliding window or pop-up that appears on-screen when the user clicks on the appropriate element. Users may also zoom in or out of the model, and/or pan across different parts of the model, to examine different parts of the model. Users may also copy or paste branches of logic from one section of the model into another section, or copy/paste branches of logic from a first model into a second model. In some cases, parts of the model may contain links to other parts of the model, such that if a user clicks on a link, the user will automatically be led to another part of the model. A viewing user may interact with a visual representation in at least some of the same ways that the viewing user might interact with the model if it were displayed within a modeling environment. In other words, the visual representation may be configured to mimic how the model would appear if it were displayed within a visual modeling environment. A single internal representation may correspond to multiple visual representations that use different styles or formatting rules to display app logic. For instance, multiple visual representations corresponding to the same internal representation may differ from one another in their use of color, elements that are included or omitted, and use of symbols, shapes, lines, colors, and/or shades to depict logic flow.

Approaches involving the above-described functionalities of visual model-based representations, visual model-based apps, and/or visual models are sometimes understood to be included by a so-called low-code application development platform or low-code app development platform. By way of example, such a low-code application development platform may further be described as software that provides a development environment used to create application software through graphical user interfaces and configuration instead of traditional hand-coded computer programming. A low-code model may enable developers of varied experience levels to create applications using a visual user interface in combination with model-driven logic. Such low-code application development platforms may produce entirely operational apps or require additional coding for specific situations. Low-code app development platforms may reduce the amount of traditional hand coding, enabling accelerated delivery of business apps. A common benefit is that a wider range of people may contribute to the app's development, not only those with formal programming skills. Low-code app development platforms may also lower the initial cost of setup, training, deployment, and maintenance.

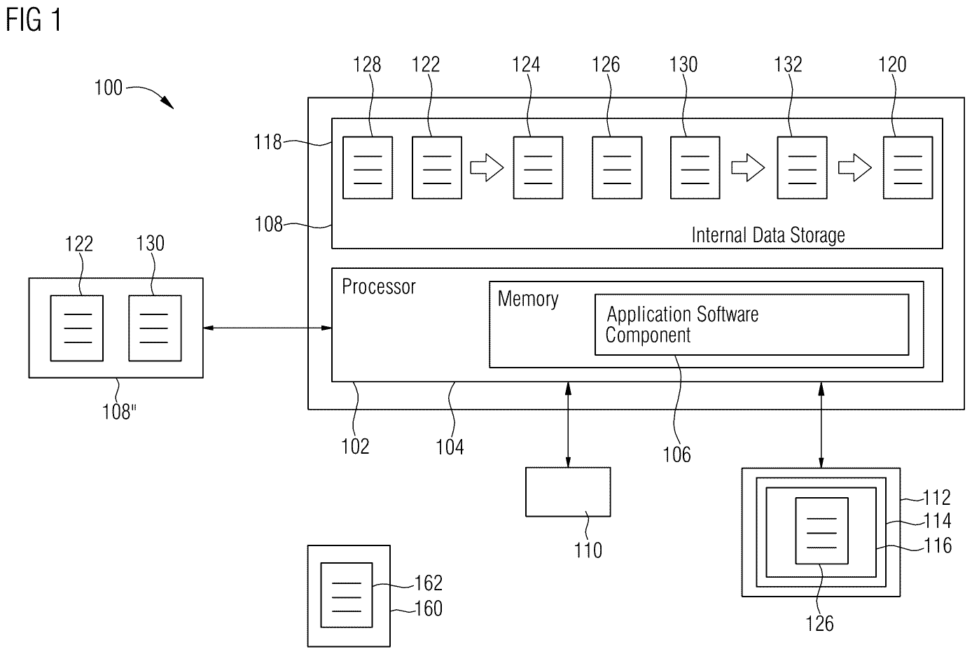

With reference to FIG. 1, a functional block diagram of a first example computer system or data processing system 100 is depicted that facilitates creating an app 120, such as creating an app 120 using branching prompts, in a product system 100. The processing system 100 may include an app development platform 118 that may, in some examples, include at least one processor 102 that is configured to execute at least one application software component 106 from a memory 104 accessed by the processor 102. The application software component 106 may be configured (i.e., programmed) to cause the processor 102 to carry out various acts and functions described herein. For example, the described application software component 106 may include and/or correspond to one or more components of an application for creating an app 120, such as creating an app 120 using branching prompts, wherein the application software component 106 may be configured to generate and store product data in a data store 108 such as a database.

By way of example, the app development platform 118 may be cloud-based, internet-based and/or be operated by a provider providing support for creating an app 120, such as creating an app 120 using branching prompts. In some examples, the user may be located close to the app development platform 118 or remote to the app development platform 118, e.g., anywhere else, e.g., using a mobile device for connecting to the app development platform 118, e.g., via the internet, wherein the mobile device may include an input device 110 and a display device 112. In some examples, the app development platform 118 may be installed and run on a user's device, such as a computer, laptop, pad, on-premises computing facility, or the like.

Examples of product systems that may be configured to include the app management and/or development, such as for creating an app 120 using branching prompts features described herein, may include the low-code software development platform of Mendix Inc., of Boston, Massachusetts, USA. This platform provides tools to build, test, deploy, iterate, develop, create, and manage apps 120 and is based on visual, model-driven software development. However, the systems and methods described herein may be used in other product systems (e.g., product lifecycle management (PLM), product data management (PDM), application lifecycle management (ALM) systems) and/or any other type of system that generates and stores product data in a database. Also, examples of databases that may be used as one or more data stores described herein include database server ap-plications such as Oracle™, Microsoft SQL™ Server, or any other type of data store that is operative to store data records.

Creating an app 120, such as creating an app 120 using branching prompts, may be a challenging and time-consuming process which may require highly skilled users or app developers with many years of training and expert domain knowledge. For example, the users need a good understanding of app development capabilities. If the users uses artificial intelligence (AI)-assisted app development capabilities, the user needs a certain level of prompt writing skills and knowledge of AI capabilities and limitations. Not all users possess the required expertise to craft effective prompts and to fine tune prompts which leads to users suffering from inefficiencies and suboptimal user experiences. Further, the output of such a suboptimal app development process, i.e., the created app 120, then may not reflect the users'intent and desired app functionalities or app look and feel. Hence, creating an app 120 may be a long and not efficient process. Further, the need of a suitable app 120 may become even more relevant if the app 120 is deployed and operated on a target device 150 to control the target device 150, especially if the app 120, the app UI 124-C or the target device 150 is safety critical so that the app 120, the app UI 124-C or the target device 150 need to comply with requirements with respect to functional safety.

To enable the enhanced creation of an app 120, such as creating an app 120 using branching prompts, the described product system or processing system 100 may include at least one input device 110 and at least one display device 112 (such as a display screen). The described processor 102 may be configured to generate a graphical user interface (GUI) 114 through the display device 112. Such a GUI 114 may include GUI elements such as buttons, links, search boxes, lists, text boxes, images, scroll bars usable by a user to provide inputs through the input device 110 that cause creating an app 120, such as creating an app 120 using branching prompts. By way of example, the GUI 114 may include an app development user interface (UI) 116 provided to a user.

In an example embodiment, the application software component 106 and/or the processor 102 may be configured to provide an app development UI 116 of an app development platform 118 to a user for developing the app 120.

As mentioned above, the app development platform 118 may provide or include the above-described functionalities of the development and the creation of the app 120, such as creating an app 120 using branching prompts. In some examples, the app development platform 118 may support visual model-based representations, visual model-based apps, and/or visual models and, by way of example, may be a visual model-based app development platform or a low-code app development platform. The app development UI 116 may provide an interactive user interface of the app development platform 118 which supports and enables the user to develop the app 120. By way of example, the app 120 may be or include a software program which on execution performs specific desired tasks.

The app 120 to be developed may be used by an end user for industrial and/or business purposes. An industrial purpose may be to use the developed app 120 for analyzing, monitoring, controlling, and/or managing an industrial field device or plant including several such fields devices, wherein the mentioned devices or plants may correspond to a target device 150 which is explained in more detail below. A business purpose may be to use the developed app 120 for shopping or retail, e.g., to generate or manage customer orders of a hardware or software product.

By way of example, the application software component 106 and/or the processor 102 may further be configured to receive first user input 122 from the user, wherein the first user input 122 is indicative of at least one app characteristic 124.

The first user input 122 as well as the below explained second user input 130 and further user input 136 may relate to the user's intent to create an app 120. The respective user input 122 may be provided by the user in natural language, e.g., in written form using a keyboard as the input device 110 and using an input text box of the app development UI 116, wherein oral input may also be possible, e.g., using a microphone as the input device 110.

In further examples, the respective user input 122 may be provided and stored in the data store 108 of the app development platform 118, e.g., by the user using the app development UI 116 and/or the input device 110. In some examples, the respective user input 122 may be received, e.g., via an application programming interface (API), from another data source 108″ or from the internet.

The first user input 122 may include or be associated with at least one app characteristic 124 of the app 120 that the user intends to create. The respective app characteristic 124 may be for one or more predefined types of apps 120. For example, for the above-mentioned industrial purposes, the respective app characteristic 124 may include control functionalities to control a target device 150 on which the app 120 may be deployed and run or which may be controlled via control signals provided by the deployed and running app 120. Herein, the control functionalities included in the respective app characteristic 124 may rely on input data received by the target device 150 or another device which is associated or communicatively coupled with the target device 150, wherein the app 120 may, according to the respective app characteristic 124, process the input data to determine the control signals in line with the control functionalities. In another example in the industrial domain, the respective app characteristic 124 may include monitoring functionalities according to which, based on input data received by the target device 150 or another device which is associated or communicatively coupled with the target device 150, an analysis and a comparison against predefined threshold values may be done to do condition monitoring with respect to the target device 150 or the other device, e.g., to determine if the respective device is operated as expected or abnormally, e.g., due to wear, a defect or a malfunction of the respective device.

By way of example, the first user input 122 may indicate an industrial purpose or use case for which the app 120 shall be used so that the corresponding app characteristic 124 may be derived from the indicated industrial purpose or use case. In further examples, the user may directly indicate the desired app characteristic 124 or app characteristic component 134 which is explained in more detail below. In some examples, the below explained large language model 128 may be used to derive the respective app characteristic 124 or app characteristic component 134 from the received respective user input 122.

In some examples, the application software component 106 and/or the processor 102 may further be configured to determine a primary prompt 126 based on the first user input 122, wherein the primary prompt 126 indicates the respective app characteristic 124, and wherein the respective prompt 126 is associated with a large language model 128 to create the app 120.

A large language model (LLM) 128 may be understood as a computational model capable of language generation or other natural language processing tasks. As language models, LLMs 128 may acquire these abilities by learning statistical relationships from vast amounts of text during a self-supervised and semi-supervised training process. In some examples, LLMs 128 may use artificial neural networks built with a decoder-only transformer-based architecture, which may enable efficient processing and generation of large-scale text data. These models may acquire knowledge about syntax, semantics, and ontologies. The artificial neural networks of LLMs 128 may contain a billion to a trillion weights and are (pre-)trained using self-supervised learning and semi-supervised learning. Some notable LLMs 128 include among others OpenAI's GPT series of models, Google's Gemini, Meta's LLaMA family of models, and IBM's Granite.

A prompt may refer to instruction issued to a computer system in the form of written or spoken language. In the context of LLMs 128, the respective prompt 126 may have some similarities to a system prompt, by way of example, in that the respective program prompt 126 may guide the way the LLM 128 may interpret and respond to user queries. In some examples, the respective prompt 126 may include instructions serving as the guiding light for the LLM 128, directing the LLM's 128 behavior and providing that the generated outputs align with the intended goals. By way of example, the respective prompt 128 may include a set of instructions, guidelines, and/or contextual information provided to the LLM 128 before the LLM 128 starts to engage with user queries. The described interplay between the respective prompt 126 and the large language model 128 to create the app 120 may be example associations between the respective prompt 126 and the large language model 128.

In the present context, the respective prompt 126 and the LLM 128 may particularly be configured to support the creation of the app 120 and may further take into account the respective app characteristic 124. To this end, the primary prompt 126 as well as the below explained subsidiary prompt 132 and further prompt 138 may include the respective app characteristic 124 or include a description or explanation of the respective app characteristic 124 which is understandable for human users, e.g., also for novice users. The primary prompt 126 may be determined by or extracted from the received first user input 122, by way of example using the LLM 128. In some examples, the first user input 122 may directly include the respective app characteristic 124. In further examples, the respective app characteristic 124 may be described or paraphrased in the first user input 122 so that an analysis may be done to extract the respective app characteristic 124 from the first user input 122. Such an extraction may involve matching the content or keywords of the first user input 122 with potentially relevant app characteristics 124 and selecting the best match or the best matches among the app characteristics 124 to be indicated in the primary prompt 126.

In further examples, the subsidiary prompt 132 may be determined also based on the first user input 122. Further, the LLM 128 may be provided and stored in the data store 108 of the app development platform 118, e.g., by the user using the app development UI 116 and/or the input device 110. In some examples, the LLM 128 may be received, e.g., via an application programming interface (API), from another data source 108′.

In further examples, the application software component 106 and/or the processor 102 may further be configured to display the determined primary prompt 126 to the user via the app development UI 116.

Hence, the user may see and check the primary prompt 126 that the app development platform 118 has derived from the first user input 122. As mentioned above, the primary prompt 126 may include the respective app characteristic 124 or a description or explanation of the respective app characteristic 124. The user may then be able to compare the primary prompt 126 with the user's intent to create an app 120, in particular with the intended app functionalities and capabilities. This may enable the user to refine the primary prompt 126.

By way of example, the application software component 106 and/or the processor 102 may further be configured to receive second user input 130 input from the user, wherein the second user input 130 is indicative of a refined primary prompt 126.

The second user input 130 as well as the below explained further user input 136 may relate to the user's intent to create an app 120 and more specifically to refine the displayed primary prompt 126 or the indicated respective app characteristic 124. In some examples, the primary prompt 126 may include a comparably rough sketch of the user's intent to create an app 120 and how this may be translated into the respective app characteristic 124 so that the respective refinement may be necessary. In further examples, several acts or iterations of user interaction with the app development platform 118 may be useful or required to express or define the respective app characteristic 124. Further, by way of example, the primary prompt 126 may include inaccuracies which the user may want to remedy by inputting the second user input 130. The respective refinement may be necessary if, according to the user, the primary prompt 126 and the indicated respective app characteristic 124 do not sufficiently well agree with the user's intent to create the app 120, in particular with the intended app functionalities and capabilities.

Like the first user input 122, the second user input 130 may be provided by the user in natural language, e.g., in written form or oral form.

In some examples, the application software component 106 and/or the processor 102 may further be configured to determine a subsidiary prompt 132 based on the primary prompt 126 and the second user input 130.

The subsidiary prompt 132 may be determined by or extracted from the received second user input 126 and the primary prompt 126 which is based on the first user input 122. Herein, in some examples, the subsidiary prompt 132 may be determined from the received second user input 126 and the primary prompt 126 using the LLM 128. Similarly to the primary prompt 126, the subsidiary prompt 132 may, in some examples, may directly include the respective app characteristic 124 which may be more refined or accurate thanks to the second user input 126. In further examples, the respective app characteristic 124 may be described or paraphrased in the second user input 130 so that an analysis may be done to extract the respective app characteristic 124 from the second user input 130. Such an extraction may involve matching the content or keywords of the second user input 130 with potentially relevant app characteristics 122 and selecting the best match or the best matches among the app characteristics 124 to be indicated in the subsidiary prompt 132.

The application software component 106 and/or the processor 102 may further be configured to create the app 120 using the subsidiary prompt 132 and the large language model 128.

In some examples, the app development platform 118 may provide the subsidiary prompt 132 to the LLM 128, wherein the output of the LLM 128 may then be used by the app development platform 118 to create the app 120.

Herein, the app development platform 118 together with subsidiary prompt 132 and the LLM 128 may be particularly suitable to support non-expert users to develop and refine their desired app characteristic 124 and then to develop the app 120 according to the app characteristic 124. Especially for non-expert users, providing the respective user input 122, 130 in natural language and, e.g., not using algorithms, step-by-step specifications of procedures, or writing code in one or more programming languages, may make the suggested approach very accessible, convenient, and efficient.

By way of example, the respective app characteristic 124 may include an app model 124-A, an app workflow 124-B, an app UI 124-C, an app wireframe 124-D, an app rule, an app logic, an app functionality, an app theme 124-E, an app API, an app target operation environment, or any combination thereof.

By way of example, the app model 124-A may be understood in the above-described context of model-based app development and may correspond to or include the above-mentioned models or visual models used for low-code application development. The app model 124-A may describe the information or data used by the app 120, e.g., in a visual way, e.g., in the form of a graph. In some examples, the graph and the (default) model may be used interchangeably. Further, the app model 124-A may be a data model which may abstract the structure of a relational database management system (RDBMS) which may store the industrial or business data which may power the app 120. The app model 124-A may include information on input and output variables of the app 120 and how the input and output variables may be interlinked in a meaningful way to fulfill the purpose of the app 120. Further details of such app models 124-A are provided below.

The app workflow 124-B may include an algorithm to process the input variables of the app 120 to obtain the output variables of the app 120. Herein, the app workflow 124-B may include one or more tasks which may be executed in the course of the app workflow 124-B. In the context of the above-mentioned industrial purposes, such an app workflow 124-B may include controlling a target device 150 on which the app 120 may be deployed and run or which may be controlled via control signals provided by the deployed and running app 120. In some examples, the mentioned tasks may include providing an app UI 124-C on the target device 150 on which the app 120 is deployed and running, wherein the app UI 124-C may include several UI elements which are arranged in the app UI 124-C using the wireframe layout 134-D1. In further examples, the app workflow 124-B may include retrieving sensor data, carrying out an analysis and a comparison against predefined threshold values for condition monitoring purposes of the target device 150 or another device communicatively connected with the target device 150, e.g., to determine if the respective device is operated as expected or abnormally, e.g., due to wear, a defect or a malfunction of the respective device, wherein a notification or an alarm may be provided to the app user in case of an abnormal operation of the respective device.

By way of example, the app UI 124-C may be the user interface of the app 120 which is deployed and running on the target device 150. Herein, the app UI 124-C may be arranged to be displayed on a display device 112′ of the mentioned target device 150 via a GUI 114′. Herein, the app UI 124-C may be used to display output data of the deployed and running app 120 to the app user. In some examples, the app user may provide user input to the deployed and running app 120 via the app UI 124-C or an input device of the target device 150 to manipulate data processed by the deployed and running app 120 or to retrieve data from other data sources, e.g., process the retrieved data. In further examples, the app user may provide user input to the deployed and running app 120 to specify desired output data or the way desired output data may be communicated or displayed to the app user by the deployed and running app 120.

The app wireframe 124-D may be understood as a low-fidelity or rough sketch of the app UI 124-C. For example, the app wireframe 124-D may include information on what kind of UI elements may be used in the app UI 124-C and where these UI elements may be arranged within the app UI 124-C. The app wireframe 124-D may be a rough sketch in that colors of the app UI 124-C may be ignored and, e.g., only black and white coarse-grained structures are considered so that, in some examples, no fancy design or design elements are yet included in the app wireframe 124-D, whereas such aspects may be of higher relevance for the final app UI 124-C to have a unique and characteristic look and feel of the app 120, e.g., a “corporate” look and feel of the app 120.

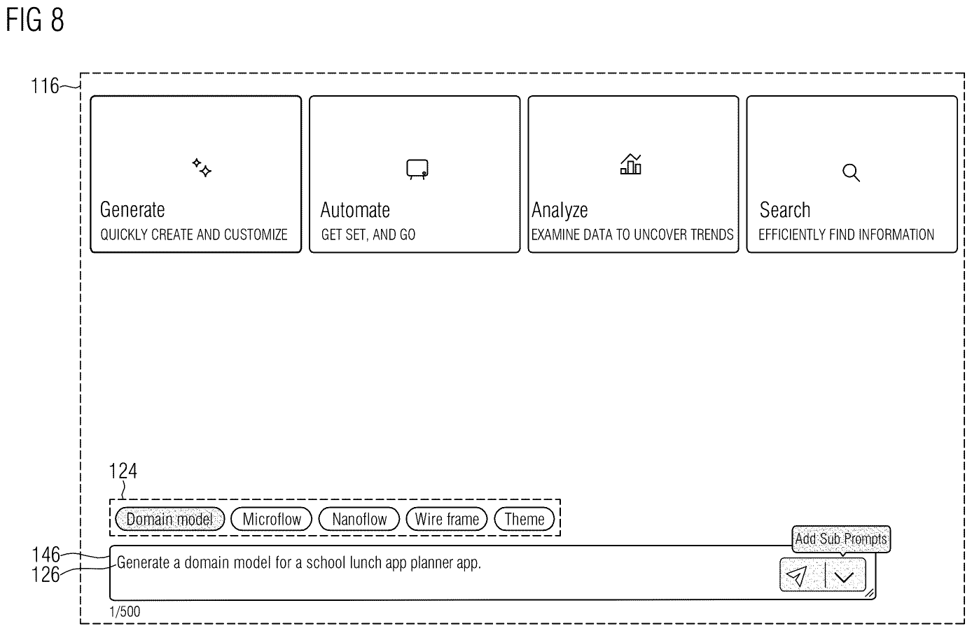

In further examples, different app wireframes 124-D may be provided for different kinds of users of the same app 120. For example, in the context of the lunch planer app of which some aspects of the app creation process are depicted in FIGS. 8-11 and explained below, the different users may be the food caterer, the students consuming the meals, and the school hosting the canteen. Herein, the different user groups may have different permissions and interests in the same lunch planer app, wherein corresponding different app wireframes 124-D may reflect these permissions, interests, and perspectives.

The app rule and similarly the app logic may be included or have similarities with the app workflow 124-B since they may also include an algorithm to process the input variables of the app 120 to obtain the output variables of the app 120. By way of example, using sensor data of the target device 150 or another device communicatively connected with the target device 150, the app rule and similarly the app logic may include one or more algorithms to carry out an analysis and a comparison of the sensor data against predefined threshold values for condition monitoring purposes of the target device 150 or the other device, e.g., to determine if the respective device is operated as expected or abnormally, e.g., due to wear, a defect or a malfunction of the respective device.

The app functionality may involve using the deployed and running app 120 for analyzing, monitoring, controlling, and/or managing an industrial field device or plant including several such fields devices, wherein the mentioned devices or plants may correspond to a target device 150. In such examples, the app development platform 118 may extract from the first user input 122 information on the app characteristic 124 in form of the app functionality, e.g., indicating that the app UI 124-C shall depict the current operational status of the target device 150, available control parameters of the target device 150, e.g., a motor speed, or a certain production throughput, available operation statuses, such as automatic, manual, and so on.

The app theme 124-E may correspond to the above-mentioned, characteristic look and feel of the app 120, wherein in some examples, colors or fonts may be used in the app UI 124-C, which may be for a certain company or a certain app functionality. For example, the app theme 124-E may include using the following color codes for conveying information which is classified as follows: blue for “information” (signage and to indicate important information; also equipment under repair), green for “safety” (safe zones; first aid equipment); orange for “warning” (danger is present especially from machinery that may cause injury); purple for “radiation” (to indicate areas where there is a risk of exposure to radiation); red for “danger/fire” (dangerous/hazardous areas; highly flammable materials; fire protection equipment, exits & alarms); and/or yellow for “physical hazards” (mark walkways, steps, unguarded areas to avoid slips, trips and falls). Further, the app theme 124-E may include dark mode or other modes that an app developer may want to use for the app 120.

Further, the app API (i.e., the application programming interface of the app 120), may be a communication interface of the deployed and running app 120 for the data transfer with other data sources, e.g., communicatively connected devices, the internet, or other data stores.

The app target operation environment may include software components or at least information on such software components which may be necessary for the processor 102′ of the target device 150 to use, e.g., run, the app 120 as intended by the user. In example embodiments, the app target operation environment may further include information on the target device 150 and, e.g., on the operating system or the available computing or memory resources of the target device 150.

In further examples, the application software component 106 and/or the processor 102 may further be configured to determine at least one app characteristic component 134 associated with the respective app characteristic 124 using the first user input 122, wherein the primary prompt 126 may further indicate the determined respective app characteristic component 134.

The respective app characteristic component 134 may further define or characterize the respective app characteristic 124 and hence improve the accuracy of the primary prompt 126 compared to the user's intent with respect to the app 120 to be developed. In some examples, the first user input 122 may directly include the respective app characteristic component 134, wherein in further examples, the respective app characteristic component 134 may be described or paraphrased in the first user input 122 so that an analysis may be done to extract the respective app characteristic component 134 from the first user input 122. Such an extraction may involve matching the content or keywords of the first user input 122 with potentially relevant the respective app characteristic components 134 and selecting the best match or the best matches among the app characteristic components 134 to be indicated in the primary prompt 126. The respective app characteristic component 134 may be determined by or extracted from the received first user input 122 using the LLM 128. Some examples of such app characteristic components 134 are provided below.

In some examples, the second user input 130 may be indicative of a specification of the determined respective app characteristic component 134.

The first user input 122 may, in some examples, not yet be sufficient to reliably extract the respective app characteristic component 134 so that, by way of example, only the type of respective app characteristic component 134 and optionally a rough estimate of the content of the respective app characteristic component 134 may be determined based on the received first user input 122.

The second user input 130 may be more specific with respect to the respective app characteristic component 134, e.g., since the displayed primary prompt 126 may indicate to the user that details or specifics of the respective app characteristic component 134 are required for a reliable creation of the app 120 in accordance with the user's intent.

The respective app characteristic component 134 may be determined or refined using the second user input 130 and/or the further user input 136, wherein the respective app characteristic component 134 may be indicated in the subsidiary prompt 132 and/or the further prompt 138.

By way of example, using the first user input 122 in an industrial purpose or use case, a corresponding app characteristic 124 may be derived, wherein related, app characteristic components 134 may already be derived. The further user input 136 may then specify the respective app characteristic component 134 in more detail, e.g., which quantities of the industrial purpose or use case may be relevant and how these quantities may be processed to generate meaningful output. By way of example, such quantities of an industrial purpose or use case may relate to physical observables, such as an electric current or voltage, a temperature, etc. or to the throughput volume of the machine per hour, etc., wherein the derived output may be a condition of the machine or a status of the manufacturing process for which the machine is used. Herein, the mentioned machine may be or include the target device 150 or another device communicatively connected with the target device 150.

In further examples, the second user input 130 may also be indicative of a specification of the respective app characteristic 124 so that the derived, respective app characteristics 124 may be refined which may then be used to refine the primary prompt 126 and/or the subsidiary prompt 132.

In further examples, the respective, determined app characteristic 124 may include an app model 124-A, wherein the determined respective app characteristic component 134 may include at least one of an app entity 134-A1, an entity attribute 134-A2 characterizing the respective app entity 134-A1, an entity association 134-A3 associating two app entities 134-A1 with each other, an app characteristic variation 134-A4, or any combination thereof.

The app model 124-A may include a plurality of app entities 134-A1, a plurality of entity attributes 134-A2, and a plurality of entity associations 134-A3. Herein, the app model 124-A may be provided in the form of a graph, wherein, a graph may refer to a structure including a set of objects where some pairs of the objects are in some sense “related.” The objects may be represented by abstractions called vertices, also called nodes or points, and each of the related pairs of vertices is called an edge, also called link or line. A graph may be depicted in diagrammatic form as a set of dots or circles for the vertices, joined by lines or curves for the edges.

In the present context, the objects or nodes of the app model 124-A or graph may include a plurality of app entities 134-A1, wherein an app entity 134-A1 may be compared to a table in traditional SQL. App entities 134-A1 may have app attributes 134-A2—which may be thought of as fields—and may have primitive types like string, int, and date-time. App entities 134-A1 may relate to each other either 1-1, 1-*, or *-* so that the graph may have corresponding edges. The edges of the graph 136 may also be considered to be associations 134-A3 linking two or more app entities 134-A1, wherein in some examples, the app associations 134-A3 may allow the app entities 134-A1 to communicate with one another. Further, an app characteristic variation 134-A4 may be understood to be a part of the app model 124-A that may relate to another, existing app 144 or another app workflow 124-B, e.g., included in the existing app 144, wherein this aspect of the existing app 144 may be taken over and be amended for the specific, currently created app 120. Hence, certain aspects, such as the app characteristics 124, of the existing app 144 may be varied and then taken over to create the current app 120 using the app characteristic variation 134-A4.

In an industrial example, the input data of the deployed and running app 120 may relate to the app entity 134-A1 “electric motor” and, e.g., include the actual rotational speed, wherein the respective app logic, or app functionality may derive a control signal as output data from the mentioned input data. Further, the app API (application programming interface) may describe how the app 120 may communicate with another app 120 or with another computer program, computer program component, or data resource. In some examples, the input data and/or the output data of an app workflow 124-B, app logic, or app functionality may be communicated from or to and another data resource. An app target operation environment of the app 120 may include information on the standard operating system and/or firmware of widely used standard target devices 150, e.g., used for standard processes managed by standard apps 120, such as monitoring or controlling the mentioned standard target devices 150. In the above industrial example, the default target operation environment may include information on the standard operating system and/or firmware of widely-used PLCs.

In the context of the above industrial example, the app characteristic 124 may include control functionalities to control a target device 150 on which the app 120 may be deployed and run or which may be controlled via control signals provided by the deployed and running app 120. One of the app entities 134-A1 included in the app model 124-A or graph may describe some properties of the target device 150, such as an identifier, and a type of target device 150 (e.g., a PLC controlling an electric motor). In this example, the app 120 may eventually be deployed and run on the target device 150 (here: the PLC). The device coupled with the target device 150 may be another app entity 134-A1 with an identifier, a type of device (e.g., an electric motor), a rated output power (e.g., 5 kW), and a maximum rotational speed (e.g., 3000 rpm). In some examples, the mentioned properties may be included in the app entity attributes 134-A2 of the respective app entity 134-A1. Another of the entities 134-A1 included in the app model 124-A or the graph may describe some properties of a complex machine including the target device 150, wherein the target device 150 drives the complex machine with a certain actual rotational speed. To control the coupled device (here: the electric motor), the actual rotational speed of the coupled device may be determined, e.g., by the target device 150 (here: the PLC), wherein in simple examples, a comparison with the maximum rotational speed may be done and, if the actual rotational speed is larger than the maximum rotational speed, the target device 150 may control the coupled device to reduce the actual rotational speed below the maximum rotational speed. Herein, the comparison and the corresponding control signal may be performed by a corresponding algorithm which may be considered as an app rule, app workflow 124-B, logic, or functionality which are explained in more detail below.

By way of example, the respective, determined app characteristic 124 may include an app workflow 124-B, wherein the determined respective app characteristic component 134 may include at least one of a workflow start event 134-B1, a workflow end event 134-B2, a workflow task 134-B3, a workflow condition 134-B4, a workflow decision 134-B5, a workflow error handling 134-B6, or any combination thereof.

For the app workflow 124-B, reference is made to the explanations above. The app workflow 124-B may start or be triggered if a workflow start event 134-B1 occurs, or a corresponding condition is fulfilled. Accordingly, the app workflow 124-B may end if a workflow end event 134-B2 occurs or a corresponding condition is fulfilled, e.g., since all acts of the app workflow 124-B have been completed. The workflow task 134-B3 may include single acts to be carried out in the course of the app workflow 124-B, wherein such acts may include, as already mentioned above, retrieving sensor data, carrying out an analysis and a comparison against predefined threshold values for condition monitoring purposes of the target device 150 or another device communicatively connected with the target device 150, e.g., to determine if the respective device is operated as expected or abnormally, e.g., due to wear, a defect or a malfunction of the respective device, wherein a notification or an alarm may be provided to the app user in case of an abnormal operation of the respective device.

A workflow condition 134-B4 may include checking whether some of the input data of the app 120 or data derived from such input data comply with a certain prerequisite. Then, a workflow decision 134-B5 may be used to choose one of several options for the app workflow 124-B to continue, e.g., providing a notification or an alarm to the app user in case of an abnormal operation of the respective device, i.e., if a workflow condition 134-B4 is fulfilled indicating the abnormal operation. Further, a workflow error handling 134-B6 may include a task or act of the app workflow 124-B that may be executed when, e.g., an unexpected error in the course of the app workflow 124-B occur, such as reporting an issue to the app user or putting the respective device in a safety mode to prevent harm to the respective device or its operator.

In some examples, the respective, determined app characteristic 124 may include an app UI 124-C, wherein the determined respective app characteristic component 134 may include at least one of a chart 134-C1, a checkbox 134-C2, a drop-down 134-C3, an image, a slider, a text box, or any combination thereof.

For the app UI 124-C, reference is made to the explanations above. The app UI 124-C may include one or more app UI elements, such as an accessibility helper, an accordion, an active filter, an activity indicator, an animation, an area chart, an attribute helper, a badge, a bar chart, a barcode scanner, a date picker, a multi select, a calendar, a cancel button, a carousel, a cell styler, a check-box filter, a checkbox, a color picker, a column chart, a data grid, a data table, a date, a date filter, a date time field, a date calculator, a date picker, a digital clock, a DIV container or an HTML DIV element, a drop down filter, a drop-down, a dynamic image viewer, a dynamic text, a feedback, a file dropper, a file manager, a gallery, an image, an image viewer, an image uploader, an intro screen, a label, a label selector, a layout grid, a light box, a line, a line chart, a list sorter, a list view, a loader, a login, a map, a menu bar, a microflow timer, a multi select drop-down, a navigation list, a navigation tree, a notification, a number filter, a pagination, a paging, a pie chart, a pop-up menu, a progress bar, a progress circle, a pusher listen, a QR code, a radio button, a range slider, a rating, a read only, a rich text, a rich text viewer, a searchable selector, a signature, a simple chart, a simple list, a slide out, a slide out context, a slider, a star rating, a static image, a switch, a tab name, a tab switcher, a table, a tag selector, a template grid, a text box search, a text filter, a text box, a thumb, a time input, a time line, a toggle button, a tooltip, a tree node, a tree view, a tree table, a video player, a web view, or any combination thereof. Further, by way of example, two or more of the mentioned app UI elements may be combined to form a respective UI component which may also be included in the app UI 124-C.

By way of example, the respective, determined app characteristic 124 may include an app wireframe 124-D, wherein the determined respective app characteristic component 134 may include at least one of a wireframe layout 134-D1, a wireframe navigation 134-D2, a wireframe component 134-D3, a wireframe content 134-D4, a wireframe interaction 134-D5, or any combination thereof.

For the app wireframe 124-D, reference is made to the explanations above. The wireframe layout 134-D1 may indicate where and how in the app UI 124-C certain of the app UI elements may be arranged. The wireframe navigation 134-D2 may include interactive app UI element that allows the user of the app 120 to navigate, e.g., from one app UI 124-C or app page to another app UI 124-C or app page of the app 120. Herein, the wireframe interaction 134-D5 may relate to the wireframe navigation 134-D2 and may provide the sorts of available interactions of the app 120 with the app user, e.g., with respect to the user input and output of the app 120 to the user. Further, the wireframe content 134-D4 may include what kind of information may be displayed via the app UI elements to the user of the app 120.

In further examples, the application software component 106 and/or the processor 102 may further be configured to: display the determined subsidiary prompt 132 to the user via the app development UI 116; receive further user input 136 from the user, wherein the further user input 136 is indicative of a refined determined respective app characteristic 124 and optionally of a refined determined respective app characteristic component 134; determine a further prompt 138 based on the subsidiary prompt 132 and the further user input 136; and create the app 120 using the further prompt 138 and the large language model 128.

By way of example, the explained additional user interaction including the further user input 136 may be used to further specify and refine the respective characteristic 124 and/or the respective app characteristics component 134. Eventually, a further prompt 138 may be obtained which may reflect the user's intent of creating the app 120 as well as possible so that the eventually created app 120 matches the user's expectations as well as possible. To this end, the further prompt 138 may be determined by or extracted from the subsidiary prompt 132 and the further user input 136. In some examples, the respective user input 122, 130, 136 may directly include the respective app characteristic 124. In further examples, the respective refined app characteristic 124 and optionally of a refined respective app characteristic component 134 may be described or paraphrased in the further user input 136 so that an analysis may be done to extract these aspects from the further user input 136. Such an extraction may involve matching the content or keywords of the further user input 136 with potentially relevant app characteristics 124 and optionally app characteristic components 134 and selecting the best match or the best matches among the app characteristics 124 and optionally app characteristic components 134 to be indicated in the further prompt 138.

In further examples, the further prompt 138 may be determined also based on the first user input 122 and/or the further user input 130.

By way of example, the application software component 106 and/or the processor 102 may further be configured to display at least one available app characteristic 124 of the app 120 to the user via the app development UI 116 prior to receiving the first user input 122 input from the user.

Displaying at least one available app characteristic 124 of the app 120 to the user may facilitate and speed up the creation of the app 120, especially for novice users or novice app developers. By way of example, used or particularly popular app characteristics 124 may be displayed to the user. Further, an easy selection of one or more of the displayed app characteristic 124, allowing a selection by clicking on the displayed app characteristic 124, may be enabled to further reduce the burden of the app developer during the creation of the app 120. By way of example, app characteristics 124 of standard industrial use cases may be displayed to the user, wherein such standard industrial use cases may include condition monitoring or controlling the target device 150 or of a device which is communicatively connected with the target device 150.

By way of example, the respective user input 122, 130, 136 may further include app-specific information 140 relating to a use case of the app 120, wherein the application software component 106 and/or the processor 102 may further be configured to: provide a respective template 142 including a respective use case-specific app characteristic 124 and optionally of a respective use case-specific app characteristic component 134; determine the respective prompt 126, 132, 138 using the respective template 142; and create the app 120 using the respective prompt 126, 132, 138 and the large language model 128.

In some examples, the respective user input 122, 130, 136 may indicate an industrial use case, such as condition monitoring or controlling the target device 150 or of a device that is communicatively connected with the target device 150. Further, the respective user input 122, 130, 136 may further include app-specific information 140, such as an indication of a particular type of target device 150 or device which is communicatively connected with the target device 150, e.g., a specific type of electric motor, PLC, conveyor, etc. In such cases, a suitable template 142 may be provided reflecting the app-specific information 140 provided by the user by including corresponding use case-specific app characteristic 124 and optionally of a respective use case-specific app characteristic component 134.

Such templates 142 may be provided beforehand for certain or most popular use cases, wherein the respective template may be provided and stored in the data store 108 of the app development platform 118, e.g., by the user using the app development UI 116 and/or the input device 110. In some examples, the respective templates 142 may be received, e.g., via an application programming interface (API), from another data source 108′.

Determining the respective prompt 126, 132, 138 using the respective template 142 may facilitate and speed up the creation of the app 120, especially for novice users or novice app developers.

Further, the respective user input 122, 130, 136 may be the first user input 122, the second user input 130 or the further user input 136. The respective prompt 126, 132, 138 may be the primary prompt 126, the subsidiary prompt 132 or the further prompt 138.

In some examples, the respective user input 122, 130, 136 may include natural language, a text, a sketch, a figure, a flowchart, or any combination thereof. In further examples, the respective user input 122, 130, 136 may include a digital image which may then be analyzed, e.g., using a computer vision algorithm.

By way of example, the respective user input 122, 130, 136 may relate to an existing app 144, wherein the existing app 144 may be refined using the respective prompt 122 and the large language model 128.

The existing app 144 may have been developed by another app developer and may be already deployed and run on the target device 150 or some of the device 150. By way of example, the user may want to benefit from the knowledge included in the existing app 144, e.g., by taking over one or more aspects of the existing app 144 for the creation of the currently developed app 120. Such taken over aspects may include one or more of the explained app characteristics 124 or app characteristic components 134 of the existing app 140 for which the user may want to take over with or without amendments into the currently developed app 120. In this way, the user may leverage the knowledge and skill that is incorporated in the existing app 144 to facilitate and speed up the creation of the currently developed app 120.

In some examples, the created app 120 may correspond to the refined existing app 144.

In some examples, the application software component 106 and/or the processor 102 may further be configured to deploy the app 120 on a target device 150.

In some examples, the respective target device 150 may be physically connected or communicatively connected to another device or connected such, that the respective target device 150 may at least detect input data from the other device, e.g., by optically inspecting the other device. The respective target device 150 and/or the other device may be or include a sensor, an actuator, such as an electric motor, a valve or a robot, an inverter supplying an electric motor, a gear box, a programmable logic controller (PLC), a communication gateway, and/or other parts or components relating to industrial automation products and industrial automation in general. The respective target device 150 may be part of a complex production line or production plant, e.g., a bottle filing machine, conveyor, welding machine, welding robot, etc. In some examples, if the other device belongs to a lower level of the automation pyramid, such as the sensor/actuator or the field level, then the respective target device 150 may belong to a higher level of the automation pyramid, such as field level or the control level.

By way of example, the respective target device 150 may have an internal data store 108′ in which the deployed and operable app 120 may be stored. The respective target device 150 may, by way of example, further include a processor 102′ and a display device 112′. The described processor 102′ may be configured to generate a target device GUI 114′ through the display device 112′, wherein the GUI 114 may include an app UI 124-C of the app 120 displayed to a user of the target device 150. In further examples, the target device 150 may include a corresponding UI capable of outputting information of the app 120 and of the app UI 122 haptically or audibly.

Further, the app 120 may be understood as deployed if the activities which are required to make this app 120 available for use by the app end user on the respective target device 150 are completed. The app deployment process may include several interrelated activities with possible transitions between them. These activities may occur at the producer side (e.g., by the app developer) or at the consumer side (by the app user or end user) or both. In some examples, the app deployment process may include at least the release of the app 120 and the installation and the activation of the app 120. The release activity may follow from the completed development process and is sometimes classified as part of the development process rather than deployment process. It may include operations required to prepare a system (here: e.g., the app development platform 118 or an online app store) for assembly and transfer to the computer system(s) (here: e.g., the respective target device 150) on which it will be run in production. Therefore, it may sometimes involve determining the resources required for the system to operate with tolerable performance and planning and/or documenting subsequent activities of the deployment process. For simple systems, the installation of the app 120 may involve establishing some form of command, shortcut, script, or service for executing the software (manually or automatically) of the app 120. For complex systems, it may involve configuration of the system, (e.g., by asking the end user questions about the intended app use, or directly asking them how they would like it to be configured), and/or making all the required subsystems ready to use. Activation may be the activity of starting up the executable component of software or the app 120 for the first time (which is not to be confused with the common use of the term activation concerning a software license, which is a function of Digital Rights Management systems).

In further examples, the app 120 may be deployed and run on the target device 150 and then be used to analyze, monitor, control, and/or operate the target device 150.

The application software component 106 and/or the processor 102 may carry out an analogous method of creating an app 120, such as creating an app 120 using branching prompts. Also, the explained examples may be combined to obtain a more detailed method of creating an app 120, such as creating an app 120 using branching prompts. Further, a computer-readable medium 160 which may include a computer program product 162 is shown in FIG. 1, wherein the computer program product 162 may be encoded with executable instructions, that when executed, cause the computer system 100 or and/or the app development platform 118 to carry out the described method.

Among the advantages of the suggested method is that it allows for an improved user understanding. By structured and step by step prompting UI, the user may gain understanding of the prompt writing mechanism and how to deliver clear instruction of complex tasks to the artificial intelligence (AI) in the form of the LLM 128 by breaking down and simplifying each task. Further, the suggested method may reduce frustration during the app creation and the operation of the app 120 by providing a clear and predictable interface minimizing user confusion and frustration.

The suggested method may further increase efficiency. By anticipating user need and actions, the interface streamlines tasks and reduces user's cognitive load.

Improved user experience may also be achieved with the suggested method. By predicting user intent, AI suggestions save time and effort to write prompt from scratch.

The suggested method may offer the advantage of discoverability. Novice users might find relevant terms, features as well as processes that they did not consider earlier.

Further, the suggested method may offer enhanced control. Users may gain a better understanding of how the interface works, giving them more control over the interaction.

Thanks to the suggested method the app creators may experience an empowerment. Users are more likely to feel confident and capable when instructing generative AI.

Further, the suggested method may improve task performance. The LLM 128 may focus on simpler questions or instructions, which may lead to better accuracy and more reliable outputs compared to handling the entire complexity in one prompt. The key innovation of the suggested method may include a specific model or language describing the context to support smart and guided prompting involving industrial app model 124-A.

Furthermore, the suggested approach may be used to: create apps 120 from scratch; refine existing apps 144; further do analysis of existing apps 144; have an AI challenge/test your app, etc.

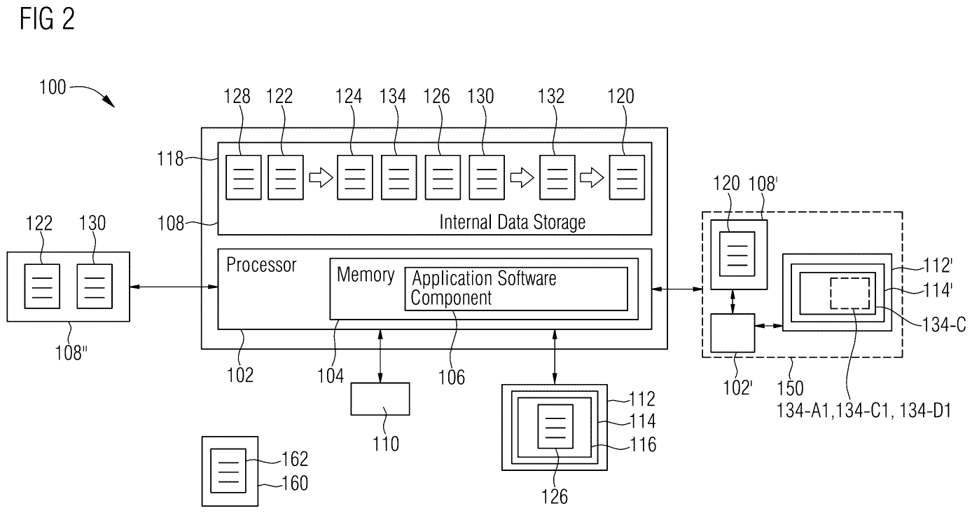

FIG. 2 depicts a functional block diagram of a second example system 100 that facilitates creating an app 120, such as creating an app 120 using branching prompts, in a product system 100.

The second example system 100 has several similarities with the first example system 100 depicted in FIG. 1. The second example system 100 may further be configured to determine at least one app characteristic component 134 associated with the respective app characteristic 124 using the first user input 122, wherein the primary prompt 126 and optionally the subsidiary prompt 132 further indicate the determined respective app characteristic component 134.

As depicted in FIG. 2, the developed app 120 may be deployed and run on a target device 150, wherein the target device 150 includes a processor 102′ that is configured to execute at least one application software component from a memory accessed by the processor 102′. The target device 150 further includes an internal data store 108′ in which the app 120 may be stored, and a display device 112′, such as a screen. The described processor 102′ may be configured to generate a target device GUI 114′ through the display device 112′, wherein the GUI 114′ may include an app UI 134-C displayed to a user of the target device 150. The app UI 134-C may include information on an app entity 134-A1, e.g., an electric motor, e.g., in form of a chart 134-C1 which may be presented using a particular wireframe layout 134-D1.

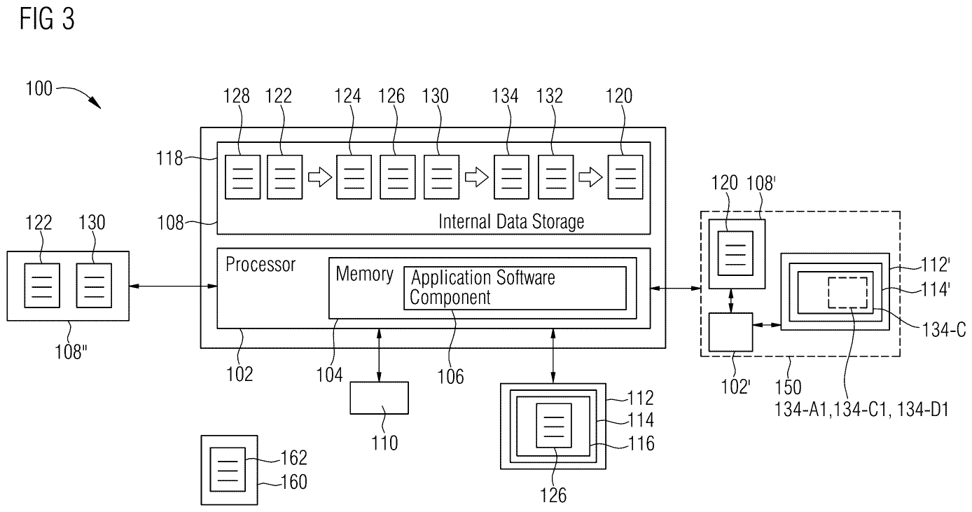

FIG. 3 depicts a functional block diagram of a third example system 100 that facilitates creating an app 120, such as creating an app 120 using branching prompts, in a product system 100.

The third example system 100 has several similarities with the first and second example systems 100 depicted in FIGS. 1 and 2. The third example system 100 may further be configured to determine at least one app characteristic component 134 associated with the respective app characteristic 124 using the second user input 130, wherein the subsidiary prompt 132 indicates the determined respective app characteristic component 134.

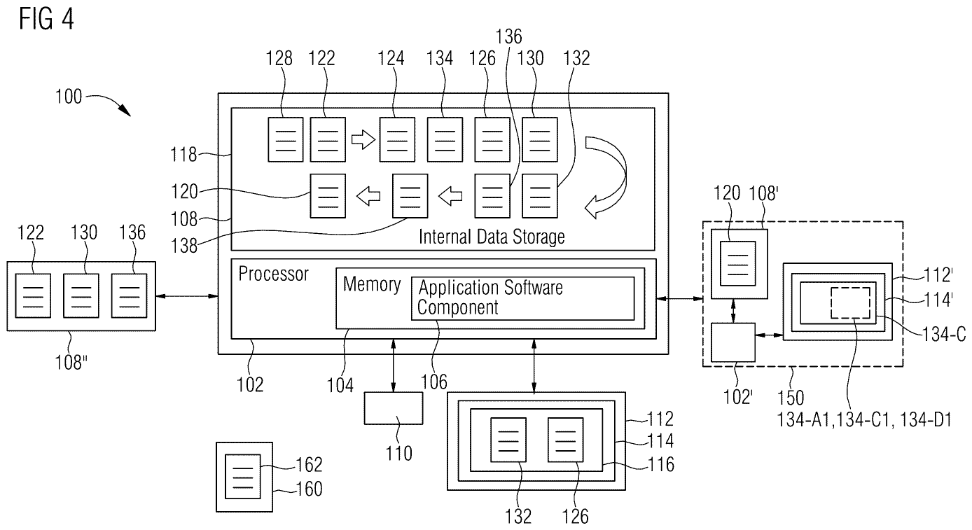

FIG. 4 depicts a functional block diagram of a fourth example system 100 that facilitates creating an app 120, such as creating an app 120 using branching prompts, in a product system 100.

The fourth example system 100 has several similarities with the second example systems 100 depicted in FIG. 2. The fourth example system 100 may further be configured to display the determined subsidiary prompt 132 to the user via the app development UI 116; to receive further user input 136 from the user, wherein the further user input 136 is indicative of a refined determined respective app characteristic 124 and optionally of a refined determined respective app characteristic component 134; to determine a further prompt 138 based on the subsidiary prompt 132 and the further user input 136; and to create the app 120 using the further prompt 138 and the large language model 128.

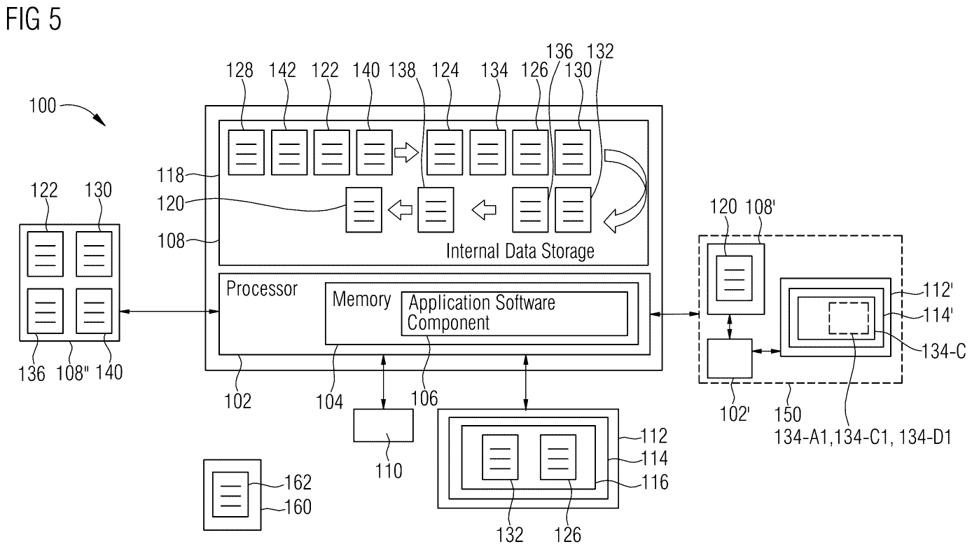

FIG. 5 depicts a functional block diagram of a fifth example system 100 that facilitates creating an app 120, such as creating an app 120 using branching prompts, in a product system 100.

The fifth example system 100 has several similarities with the fourth example systems 100 depicted in FIG. 4. The fifth example system 100 may further be configured to provide a respective template 142 including a respective use case-specific app characteristic 124 and optionally of a respective use case-specific app characteristic component 134; to determine the respective prompt 126, 132, 138 using the respective template 142; and to create the app 120 using the respective prompt 126, 132, 138 and the large language model 128, wherein the respective user input 122, 130, 136 may further include app-specific information 140 relating to a use case of the app 120.

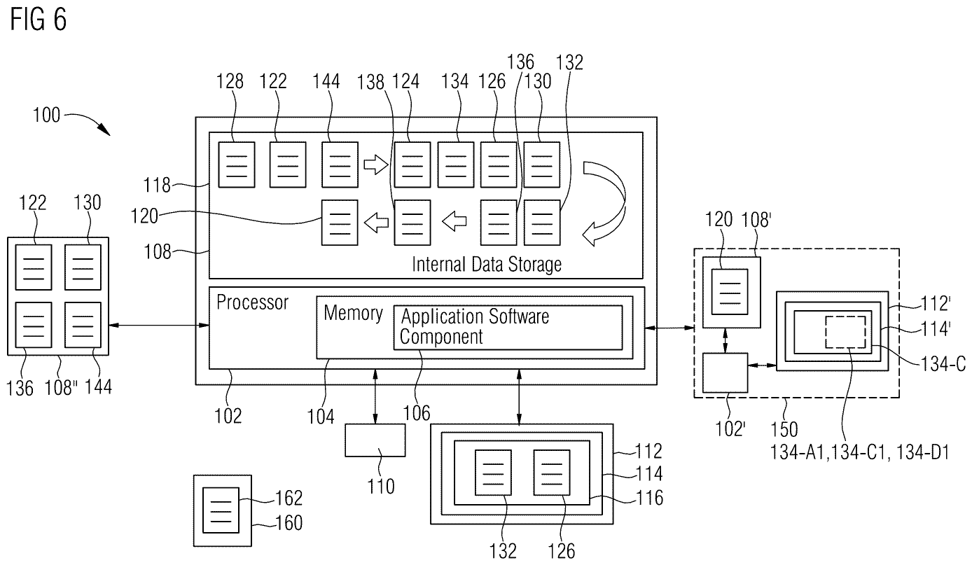

FIG. 6 depicts a functional block diagram of a sixth example system 100 that facilitates creating an app 120, such as creating an app 120 using branching prompts, in a product system 100.

The sixth example system 100 has several similarities with the fourth example systems 100 depicted in FIG. 4. In the sixth example system 100, the respective user input 122, 130, 136 may relate to an existing app 144, wherein the existing app 144 may be refined using the respective prompt 122 and the large language model 128, and wherein the created app 120 corresponds to the refined existing app 144.

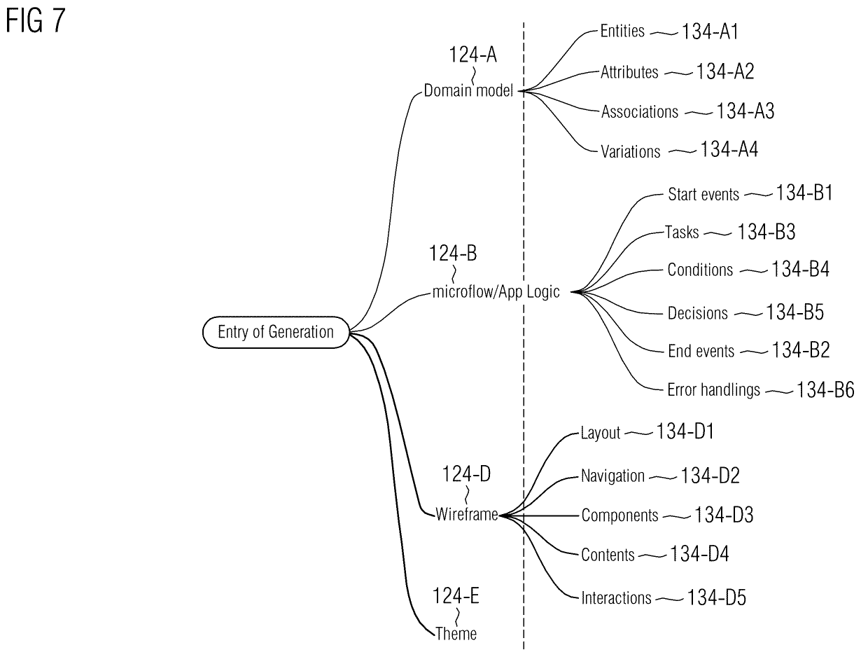

FIG. 7 depicts an example schematic overview of app characteristics 124 and app characteristic components 134 available for branching prompts in the context of facilitating creating an app 120, such as creating an app 120 using branching prompts 126, 132, 138, in a product system 100.

From left to right, FIG. 7 depicts how the prompts 126, 132, 138 may be branched and hence refined with respect to the app characteristics 124 and the corresponding app characteristic components 134. A starting point may be the first user input 122 indicating one of the app characteristics 124 of an app model 124-A (in FIG. 7 depicted as “Domain model”), an app workflow 124-B or an app logic (“microflow/App logic), an app wireframe 124-D (“Wireframe”) which may relate to an app UI 124-C, or an app theme 124-E (“Theme”), wherein furthermore an app rule, an app functionality, an app API, or an app target operation environment, or any combination thereof, may be indicated in the first user input 122.

E.g., using the second user input 130 or the further user input 136, the app characteristics 124 may be refined, and suitable app characteristic components 134 may be determined which are explained in detail above: for the app model 124-A, an app entity 134-A1 (“Entity”), an entity attribute 134-A2 (“Attributes”) characterizing the respective app entity 134-A1, an entity association 134-A3 (“Associations”) associating two app entities 134-A1 with each other, an app characteristic variation 134-A4 (“Variations”), or any combination thereof may be determined. For the app workflow 124-B, a workflow start event 134-B1 (“Start events”), a workflow end event 134-B2 (“End events”), a workflow task 134-B3 (“Tasks”), a workflow condition 134-B4 (“Conditions”), a workflow decision 134-B5 (“Decisions”), a workflow error handling 134-B6 (“Error handlings,” or any combination thereof may be determined. For the app theme 124-E, a wireframe layout 134-D1 (“Layout”), a wireframe navigation 134-D2 (“Navigation”), a wireframe component 134-D3 (“Components”), a wireframe content 134-D4 (“Contents”), a wireframe interaction 134-D5 (“Interactions”), or any combination thereof may be determined. Further, for the app theme 124-E, one or more of the above-mentioned aspects relating to the characteristic look and feel of the app 120 may be determined.

FIG. 8 depicts a first aspect of an example app development user interface 116 that facilitates creating an app 122, such as creating an app using branching prompts, in a product system 100.

The app development UI 116 includes in its top four tiles, wherein with the leftmost “Generate” tile, the creation of an app 120 may be initiated. Using the input window 146 included in the app development UI 116, the user may provide the first user input 122 with which the app development platform 118 may determine the primary prompt 126. To facilitate praising a suitable primary prompt 126, the app development UI 116 may display available app characteristics 124, e.g., the depicted “Domain model” corresponding to the app model 124-A, “Microflow” and “Nanoflow” corresponding to the app workflow 124-B, “Wired frame” corresponding to the app wireframe 124-D, and “Theme” corresponding to the app theme 124-E.

By way of example, the user may provide the first user input 122 indicating the user's intent to create an app to facilitate planning the lunch in school. Further, the user may select the depicted “Domain model” corresponding to the app model 124-A by clicking on the corresponding UI element displayed in the app development UI 116, wherein this selection may be included in the first user input 122. Using this first user input 122, the app development platform 118 may using an LLM 128, then determine the primary prompt 126 “Generate a domain model for school lunch app planner app.”

In further examples, an app 120 for one of the above-explained industrial examples or use cases may be created similarly to the aspects depicted in the FIGS. 8 to 11 and described below.

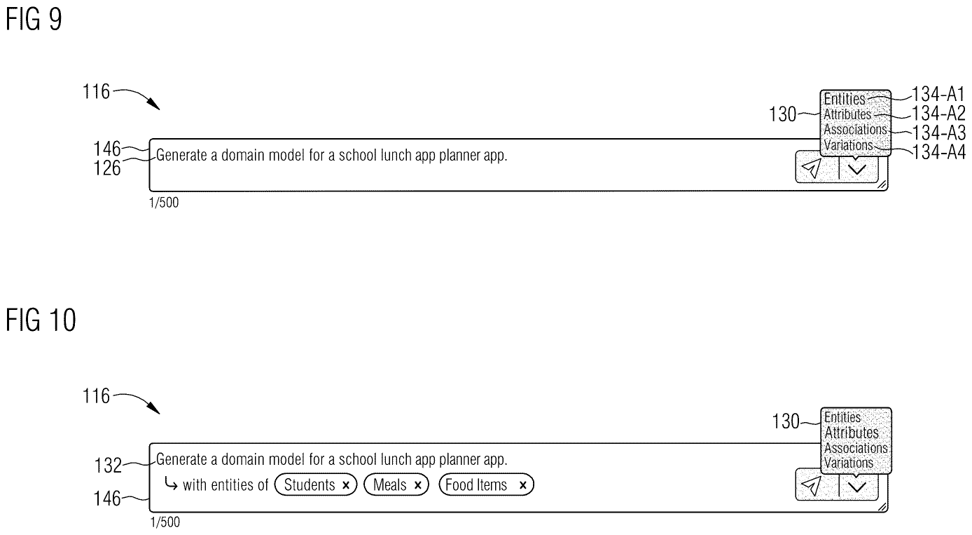

FIG. 9 depicts a second aspect of an example app development user interface 116 that facilitates creating an app 122, such as creating an app using branching prompts, in a product system 100. By way of example, the app development UI 116 depicted in FIG. 9 may correspond to the app development UI 116 depicted in FIG. 8 and explained above.

In the depicted app development UI 116, the user may provide the second user input 130 using the drop-down menu on the right allowing a selection among the four app characteristic components app entity 134-1 (depicted in FIG. 9 as “Entities”), app attribute 134-2 (“Attributes”), app associations 134-3 (“Associations”), and app variations 134-4 (“Variations”). For example, the user may select the app characteristic component app entity 134-1 to refine the primary prompt 126.

FIG. 10 depicts a third aspect of an example app development user interface 116 that facilitates creating an app 122, such as creating an app using branching prompts, in a product system 100. By way of example, the app development UI 116 depicted in FIG. 10 may correspond to the app development UIs 116 depicted in FIGS. 8 and 9 and explained above.

Using the second user input 130 and the primary prompt 126 which is indicative of the first user input 122, the app development platform 118 may using an LLM 128, determine the subsidiary prompt 132. Compared to the primary prompt 126, the subsidiary prompt 132 is more refined in that it includes additional information on the app entities 134-1 which may be required for the domain model 124-A to create the desired app 120. In the current example, these app entities 134-1 include “Students,” “Meals,” and “Food Items.” These app entities 134-1 may then further be specified, e.g., involving further user input 136.

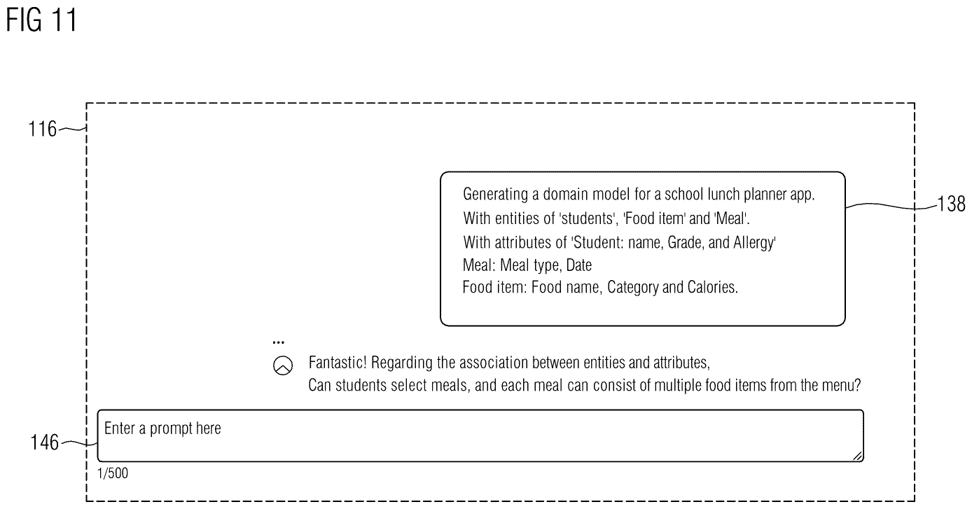

FIG. 11 depicts a fourth aspect of an example app development user interface 116 that facilitates creating an app 122, such as creating an app using branching prompts, in a product system 100. By way of example, the app development UI 116 depicted in FIG. 11 may correspond to the app development UIs 116 depicted in FIGS. 8 to 10 and explained above.

After providing the first user input 122, the second user input 130, and the further user input 136, the app development platform 118 may using an LLM 128, determine a further prompt 138. Herein, the further prompt may be determined also based on the primary prompt 126 and the subsidiary prompt 132.

In the present example, the user may select the app characteristic component 134 app entity attribute 134-A1 to further refine the subsidiary prompt 132. Accordingly, the further prompt 138 may include additional information of the domain model 124-A in the form of app entity attributes 134-A2 “name,” “grade,” and “allergy” for the app entity 134-A1 “Students.” Further, the further prompt 138 may include additional information for the domain model 124-A in the form of app entity attributes 134-A2 “meal type,” and “date” for the app entity 134-A1 “meal.” Finally, the further prompt 138 may include additional information of the domain model 124-A in the form of app entity attributes 134-A2 “food name,” “category,” and “calories” for the app entity 134-A1 “food item.”

Using the explained further prompt 138, the app development platform 118 may create a corresponding app 120 using a large language model 128. In some examples, the further prompt 138 may further be refined by additional, further user input which may lead to even more targeted apps 120.

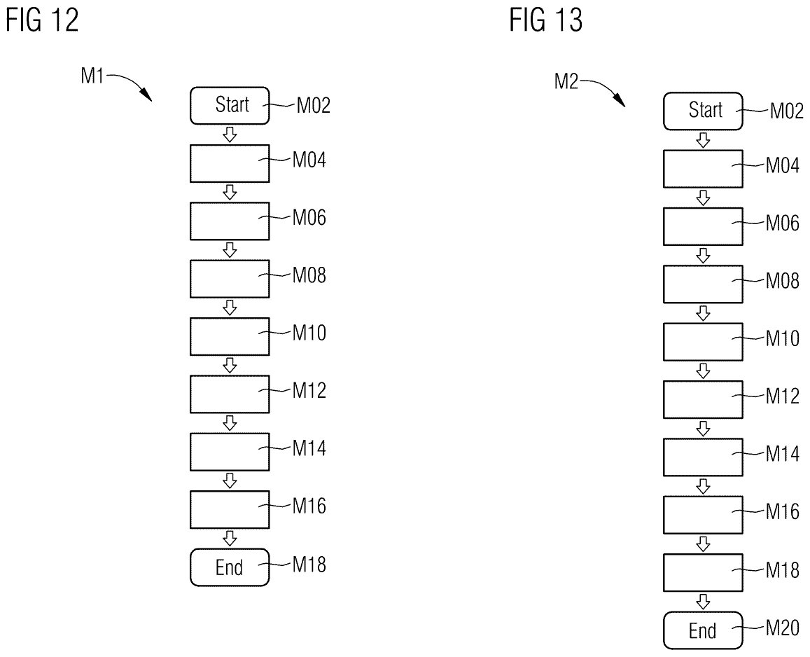

FIG. 12 depicts a flow diagram of a first example methodology M1 that facilitates creating an app, such as creating an app using branching prompts, in a product system 100.

These acts may include an act M1 of providing an app development user interface (UI) of an app development platform to a user for developing the app; an act M06 of receiving first user input from the user, wherein the first user input is indicative of at least one app characteristic; an act M08 of determining a primary prompt based on the first user input, wherein the primary prompt indicates the respective app characteristic, and wherein the respective prompt is associated with a large language model to create the app; an act M10 of displaying the determined primary prompt to the user via the app development UI; an act M12 of receiving second user input from the user, wherein the second user input is indicative of a refined primary prompt; an act M14 of determining a subsidiary prompt based on the primary prompt and the second user input; and an act M16 of creating the app using the subsidiary prompt and the large language model. At M18 the methodology may end.

The methodology M1 may include other acts and features discussed previously with respect to the computer-implemented method of creating an app, such as creating an app using branching prompts.

FIG. 13 depicts a flow diagram of a second example methodology M2 that facilitates creating an app, such as creating an app using branching prompts, in a product system 100.

These acts may include: an act M2 of providing an app development user interface (UI) of an app development platform to a user for developing the app; an act M06 of receiving first user input from the user, wherein the first user input is indicative of at least one app characteristic; an act M08 of determining a primary prompt based on the first user input, wherein the primary prompt indicates the respective app characteristic, and wherein the respective prompt is associated with a large language model to create the app; an act M10 of determining at least one app characteristic component associated with the respective app characteristic using the first user input, wherein the primary prompt further indicates the determined respective app characteristic component; an act M12 of displaying the determined primary prompt to the user via the app development UI; an act M14 of receiving second user input from the user, wherein the second user input is indicative of a refined primary prompt; an act M16 of determining a subsidiary prompt based on the primary prompt and the second user input; and an act M18 of creating the app using the subsidiary prompt and the large language model. At act M20, the methodology may end.

The methodology M2 may include other acts and features discussed previously with respect to the computer-implemented method of creating an app, such as creating an app using branching prompts.

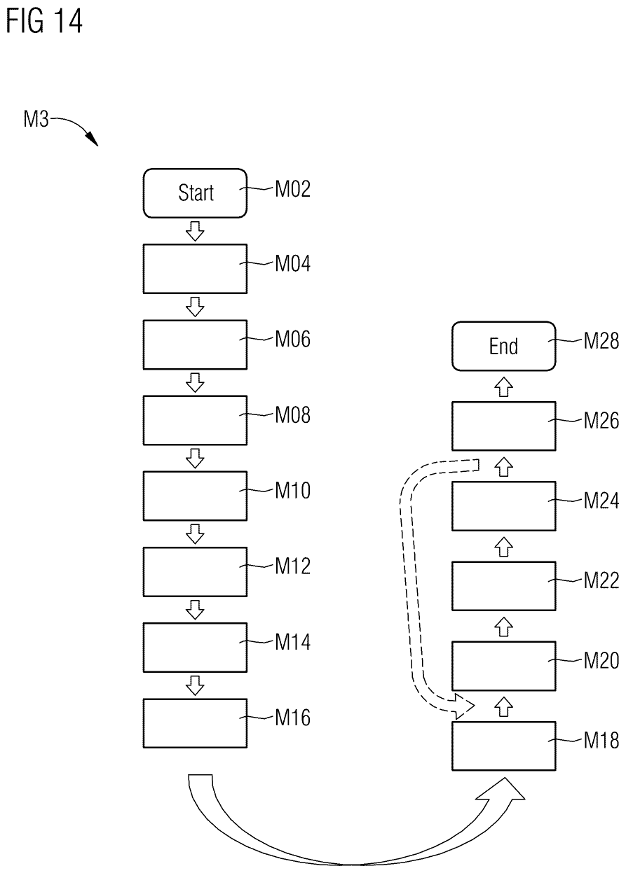

FIG. 14 depicts a flow diagram of a third example methodology M3 that facilitates creating an app, such as creating an app using branching prompts, in a product system 100.

These acts may include: an act M3 of providing an app development user interface (UI) of an app development platform to a user for developing the app; an act M06 of receiving first user input from the user, wherein the first user input is indicative of at least one app characteristic; an act M08 of determining a primary prompt based on the first user input, wherein the primary prompt indicates the respective app characteristic, and wherein the respective prompt is associated with a large language model to create the app; an act M10 of determining at least one app characteristic component associated with the respective app characteristic using the first user input, wherein the primary prompt further indicates the determined respective app characteristic component; an act M12 of displaying the determined primary prompt to the user via the app development UI; an act M14 of receiving second user input from the user, wherein the second user input is indicative of a refined primary prompt; an act M16 of determining a subsidiary prompt based on the primary prompt and the second user input; an act M18 of displaying the determined subsidiary prompt to the user via the app development UI; an act M20 of receiving further user input from the user, wherein the further user input is indicative of a refined determined respective app characteristic and optionally of a refined determined respective app characteristic component; an act M22 of determining a further prompt based on the subsidiary prompt and the further user input; an act M24 of creating the app using the subsidiary prompt and the large language model; and an act M26 of creating the app using the further prompt and the large language model. At act M28, the methodology may end. Herein, the acts M24 and M26 may be united into one act of creating the app using the subsidiary prompt, the further prompt, and the large language model.

In some examples, after the act M24 of creating the app using the subsidiary prompt and the large language model, the acts M20 to M24 may be repeated or iterated to receive further user input to further refine the subsidiary prompt or the further prompt as indicted in FIG. 14 with the dashed arrow. Optionally, the repetition or iteration process may include displaying the determined further prompt to the user. In further examples, the repetition or iteration process may start after the act M22 of determining a further prompt based on the subsidiary prompt and the further user input and may include displaying the determined further prompt to the user.

The methodology M3 may include other acts and features discussed previously with respect to the computer-implemented method of creating an app, such as creating an app using branching prompts.

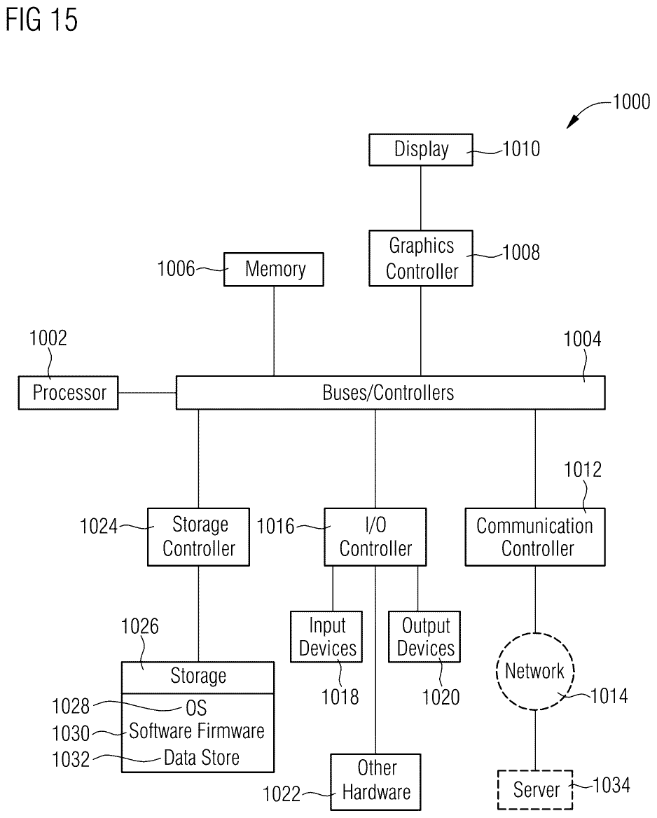

FIG. 15 depicts a block diagram of a data processing system 1000 (also referred to as a computer system) in which an embodiment may be implemented, for example, as a portion of a product system, and/or other system operatively configured by software or otherwise to perform the processes as described herein. The data processing system 1000 may include the computer or IT system or data processing system 100 mentioned above. The data processing system depicted includes at least one processor 1002 (e.g., a CPU) that may be connected to one or more bridges/controllers/buses 1004 (e.g., a north bridge, a south bridge). One of the buses 1004, for example, may include one or more I/O buses such as a PCI Express bus. Also connected to various buses in the depicted example may include a main memory 1006 (RAM) and a graphics controller 1008. The graphics controller 1008 may be connected to one or more display devices 1010. In certain embodiments, one or more controllers (e.g., graphics, south bridge) may be integrated with the CPU (on the same chip or die). Examples of CPU architectures include IA-32, x86-64, and ARM processor architectures.

Other peripherals connected to one or more buses may include communication controllers 1012 (Ethernet controllers, WiFi controllers, cellular controllers) operative to connect to a local area network (LAN), Wide Area Network (WAN), a cellular network, and/or other wired or wireless networks 1014 or communication equipment.

Further components connected to various busses may include one or more I/O controllers 1016 such as USB controllers, Bluetooth controllers, and/or dedicated audio controllers (connected to speakers and/or microphones). Various peripherals may be connected to the I/O controller(s) (via various ports and connections) including input devices 1018 (e.g., keyboard, mouse, pointer, touch screen, touch pad, drawing tablet, trackball, buttons, keypad, game controller, gamepad, camera, microphone, scanners, motion sensing devices that capture motion gestures), output devices 1020 (e.g., printers, speakers) or any other type of device that is operative to provide inputs to or receive outputs from the data processing system. Also, certain devices referred to as input devices or output devices may both provide inputs and receive outputs of communications with the data processing system. For example, the processor 1002 may be integrated into a housing (such as a tablet) that includes a touch screen that serves as both an input and display device. Further, certain input devices (e.g., a laptop) may include a plurality of different types of input devices (e.g., touch screen, touch pad, keyboard). Also, other peripheral hardware 1022 connected to the I/O controllers 1016 may include any type of device, machine, or component that is configured to communicate with a data processing system.

Additional components connected to various busses may include one or more storage controllers 1024 (e.g., SATA). A storage controller may be connected to a storage device 1026 such as one or more storage drives and/or any associated removable media, which may be any suitable non-transitory machine usable or machine-readable storage medium. Examples include nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also, in some examples, a storage device such as an SSD may be connected directly to an I/O bus 1004 such as a PCI Express bus.

A data processing system in accordance with an embodiment of the present disclosure may include an operating system 1028, software/firmware 1030, and data stores 1032 (that may be stored on a storage device 1026 and/or the memory 1006). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may include Microsoft Windows™, Linux™, UNIX™, iOS™, and Android™ operating systems. Also, examples of data stores include data files, data tables, relational database (e.g., Oracle™, Microsoft SQL™ Server), database servers, or any other structure and/or device that is capable of storing data, which is retrievable by a processor.

The communication controllers 1012 may be connected to the network 1014 (not a part of data processing system 1000), which may be any public or private data processing system network or combination of networks, as known to those of skill in the art, including the Internet. Data processing system 1000 may communicate over the network 1014 with one or more other data processing systems such as a server 1034 (also not part of the data processing system 1000). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

Further, the term “controller” means any device, system, or part thereof that controls at least one operation, whether such a device is implemented in hardware, firmware, software, or some combination of at least two of the same. The functionality associated with any particular controller may be centralized or distributed, whether locally or remotely.

In addition, data processing systems may be implemented as virtual machines in a virtual machine architecture or cloud environment. For example, the processor 1002 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system may vary for particular implementations. For example, the data processing system 1000 in this example may correspond to a computer, workstation, server, PC, notebook computer, tablet, mobile phone, and/or any other type of apparatus/system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

Also, the processor described herein may be located in a server that is remote from the display and input devices described herein. In such an example, the described display device and input device may be included in a client device that communicates with the server (and/or a virtual machine executing on the server) through a wired or wireless network (which may include the Internet). In some embodiments, such a client device, for example, may execute a remote desktop application or may correspond to a portal device that carries out a remote desktop protocol with the server in order to send inputs from an input device to the server and receive visual information from the server to display through a display device. Examples of such remote desktop protocols include Teradici's PCoIP, Microsoft's RDP, and the RFB protocol. In such examples, the processor described herein may correspond to a virtual processor of a virtual machine executing in a physical processor of the server.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 1000 may conform to any of the various current implementations and practices known in the art.

Also, the words or phrases used herein should be construed broadly, unless expressly limited in some examples. For example, the terms “comprise” and “include,” as well as derivatives thereof, mean inclusion without limitation. The singular forms “a,” “an,” and “the” are intended to include the plural forms as well, unless the context clearly indicates otherwise. Further, the term “and/or” as used herein refers to and encompasses any and all combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first,” “second,” “third,” and so forth may be used herein to describe various elements, functions, or acts, these elements, functions, or acts should not be limited by these terms. These numeral adjectives are used to distinguish different elements, functions or acts from each other. For example, a first element, function, or act may be termed a second element, function, or act, and, similarly, a second element, function, or act may be termed a first element, function, or act, without departing from the scope of the present disclosure.

In addition, phrases such as “processor is configured to” carry out one or more functions or processes, may mean the processor is operatively configured to or operably configured to carry out the functions or processes via software, firmware, and/or wired circuits. For example, a processor that is configured to carry out a function/process may correspond to a processor that is executing the software/firmware, which is programmed to cause the processor to carry out the function/process and/or may correspond to a processor that has the software/firmware in a memory or storage device that is available to be executed by the processor to carry out the function/process. Further, a processor that is “configured to” carry out one or more functions or processes may also correspond to a processor circuit particularly fabricated or “wired” to carry out the functions or processes (e.g., an ASIC or FPGA design). Further the phrase “at least one” before an element (e.g., a processor) that is configured to carry out more than one function may correspond to one or more elements (e.g., processors) that each carry out the functions and may also correspond to two or more of the elements (e.g., processors) that respectively carry out different ones of the one or more different functions.

In addition, the term “adjacent to” may mean that an element is near to but not in contact with a further element or that the element is in contact with the further portion, unless the context clearly indicates otherwise.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present patent document should be read as implying that any particular element, step, act, or function is an essential element, which must be included in the claim scope: the scope of patented subject matter is defined only by the allowed claims.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method of creating an app, the computer-implemented method comprising:
providing an app development user interface (UI) of an app development platform to a user for developing the app;
receiving first user input from the user, wherein the first user input is indicative of at least one app characteristic;
determining a primary prompt based on the first user input, wherein the primary prompt indicates a respective app characteristic, and wherein the primary prompt is associated with a large language model to create the app;
displaying the primary prompt to the user via the app development UI;
receiving second user input from the user, wherein the second user input is indicative of a refined primary prompt;
determining a subsidiary prompt based on the primary prompt and the second user input; and
creating the app using the subsidiary prompt and the large language model.

2. The computer-implemented method of claim 1, wherein the respective app characteristic comprises an app model, an app workflow, an app UI, an app UI wireframe, an app rule, an app logic, an app functionality, an app theme, an app API, an app target operation environment, or any combination thereof.

3. The computer-implemented method of claim 1, further comprising:
determining at least one app characteristic component associated with the respective app characteristic using the first user input,
wherein the primary prompt further indicates the at least one app characteristic component.

4. The computer-implemented method of claim 3, wherein the second user input is indicative of a specification of the at least one app characteristic component.

5. The computer-implemented method of claim 3, wherein the respective app characteristic comprises an app model, and
wherein the at least one app characteristic component comprises an app entity, an entity attribute characterizing the respective app entity, an entity association associating two app entities with each other, an app characteristic variation, or any combination thereof.

6. The computer-implemented method of claim 3, wherein the respective app characteristic comprises an app workflow, and
wherein the at least one app characteristic component comprises a workflow start event, a workflow end event, a workflow task, a workflow condition, a workflow decision, a workflow error handling, or any combination thereof.

7. The computer-implemented method of claim 3, wherein the respective app characteristic comprises an app UI, and
wherein the at least one app characteristic component comprises a chart, a checkbox, a drop-down, an image, a slider, a text box, or any combination thereof.

8. The computer-implemented method of claim 3, wherein the respective app characteristic comprises an app wireframe, and
wherein the at least one app characteristic component comprises a wireframe layout, a wireframe navigation, a wireframe component, a wireframe content, a wireframe interaction, or any combination thereof.

9. The computer-implemented method of claim 1, further comprising
displaying the subsidiary prompt to the user via the app development UI;
receiving further user input from the user, wherein the further user input is indicative of a refined determined respective app characteristic;
determining a further prompt based on the subsidiary prompt and the further user input; and
creating the app using the further prompt and the large language model.

10. The computer-implemented method of claim 9, wherein the further user input is additionally indicative of a refined determined respective app characteristic component.

11. The computer-implemented method of claim 1, further comprising:
displaying at least one available app characteristic of the app to the user via the app development UI prior to receiving the first user input from the user.

12. The computer-implemented method of claim 1, wherein the respective first or second user input further comprises app-specific information relating to a use case of the app,
wherein the method further comprises:
providing a respective template comprising a respective use case-specific app characteristic;
determining the respective prompt using the respective template; and
creating the app using the respective prompt and the large language model.

13. The computer-implemented method of claim 12, wherein the respective template further comprises a respective use case-specific app characteristic component.

14. The computer-implemented method of claim 1, wherein the respective user input comprises natural language, a text, a sketch, a figure, a flowchart, or any combination thereof.

15. The computer-implemented method of claim 1, wherein the respective user input relates to an existing app, and
wherein the existing app is refined using the respective prompt and the large language model.

16. The computer-implemented method of claim 1, further comprising:
deploying the app on a target device.

17. A computer system comprising:
at least one processor; and
at least one memory in communication with the at least one processor,
wherein the at least one processor and the at least one memory are configured to:
provide an app development user interface (UI) of an app development platform to a user for developing an app;
receive first user input from the user, wherein the first user input is indicative of at least one app characteristic;
determine a primary prompt based on the first user input, wherein the primary prompt indicates a respective app characteristic, and wherein the primary prompt is associated with a large language model to create the app;
display the primary prompt to the user via the app development UI;
receive second user input from the user, wherein the second user input is indicative of a refined primary prompt;
determine a subsidiary prompt based on the primary prompt and the second user input; and
create the app using the subsidiary prompt and the large language model.

18. A computer program product or a computer-readable medium comprising the computer program product, wherein the computer program product comprises computer program code that, when executed by a computer system, causes the computer system to:
provide an app development user interface (UI) of an app development platform to a user for developing an app;
receive first user input from the user, wherein the first user input is indicative of at least one app characteristic;
determine a primary prompt based on the first user input, wherein the primary prompt indicates a respective app characteristic, and wherein the primary prompt is associated with a large language model to create the app;
display the primary prompt to the user via the app development UI;
receive second user input from the user, wherein the second user input is indicative of a refined primary prompt;
determine a subsidiary prompt based on the primary prompt and the second user input; and
create the app using the subsidiary prompt and the large language model.
